(19) United States
(12) Patent Application Publication
(10) Pub. No.: US 2013/0048657 A1
(43) Pub. Date: Feb. 28, 2013

(54) PLASTIC PAINT BUCKET HANDLE

(71) Applicants: John A. Heiser, JR., Rancho Santa Margarita, CA (US); Keith Francis Rukvina, Dothan, AL (US)

(72) Inventors: John A. Heiser, JR., Rancho Santa Margarita, CA (US); Keith Francis Rukvina, Dothan, AL (US)

(73) Assignee: John A. Heiser, JR.

(21) Appl. No.: 13/221,056

(22) Filed: Aug. 30, 2011

(51) Int. Cl. B65D 25/32; B23P 11/00

(52) U.S. Cl. 220/760; 220/754; 29/428

(57) ABSTRACT

A plastic handle for a paint bucket has a unitary elongated hard plastic body terminating at opposed ends. Located at each end are respective outwardly-biased, inwardly-bendable clip arms that together establish a resilient clip for engaging a hub of a paint bucket. An alternate clip may be a single unitary arrow-shaped structure. Surrounding each clip is a respective raised hub cover with opposed chamfered sides configured for conveniently Fitting in a paint shaker machine. Wider portions of the body extend inwardly from each end and merge with a central narrower portion that has finger bumps formed on it for gripping. Owing to the small width of the central narrow portion, the handle is disposed very close to the paint bucket in a stowed position in which the handle is moved down against the bucket, to facilitate convenient close stowage of multiple buckets.

### FIELD OF THE INVENTION

The present application relates generally to plastic paint bucket handles.

### BACKGROUND OF THE INVENTION

Paint buckets including plastic buckets typically use wire-like metal bails for handles. While being inexpensive and easy to install by machine, present principles understand that metal bails complicate recycling used plastic buckets.

### SUMMARY OF THE INVENTION

As also understood herein, a plastic handle must not only be configured to fit onto existing paint bucket hubs, but also should not unduly impede placing multiple buckets close together on a pallet or impede placement of a single bucket into existing shaker machines to mix the paint. The plastic handle is elongated in shape and includes a unitary elongated plastic body terminating at opposed ends. A resilient clip for engaging a hub of a paint bucket is located at each end of the plastic handle and is established by two outwardly-biased, inwardly-bendable clip arms. Each of the two clips is surrounded by a hub cover that is formed with opposed chamfered edges configured for engagement with a paint shaker machine. Extending inwardly from each end of the plastic handle are wider portions of the body that merge with a central narrower portion. When the plastic handle is attached to a paint bucket and the handle is disposed in a stowed position in which the handle is moved own against the side of the paint bucket, the central narrower portion of the handle facilitates close stowage of multiple buckets.

Accordingly, the body of the plastic handle is made of a hard plastic material such as nylon, polycarbonate, polyethylene terephthalate (PET), polypropylene, or other suitable rugged, typically hard and transversely flexible plastic. The central narrower portion of that same body has a middle segment and two narrower end segments. Finger bumps for gripping are formed only on the middle segment of the central narrower portion of the plastic handle.

Each of the clip arms located on either end of the plastic handle are formed with an outer surface tapering outwardly from a free end of the clip arm and then at an inflection point extending back inwardly such that when the clip is advanced into a receptacle of the bucket hub free ends first. The clip arms ride against a periphery of the receptacle, consequently urging the clip arms toward each other until the inflection point clears the periphery. The clip arms move away from each other under the influence of material bias once clearance of the internal peripheral receptacle edge by the inflection points is reached. This effectively engages the clip by trapping it in the receptacle.

Each of the two clips on respective ends of the plastic handle is surrounded by a hub cover with opposed chamfered edges. The chamfered edges are straight and parallel to each other. The defined distance between opposed chamfered edges is three quarters of an inch.

The plastic paint bucket handle has an elongated plastic body with opposed clip ends. Clips configured for engaging respective receptacles of a paint container form the respective clip ends. Respective hub covers surround each clip and define a non-circular periphery.

The clips on opposed ends of an elongated plastic handle engage with a plastic paint container and provide the container with a handle for carrying the container. The plastic handle has end portions wider than a middle portion to facilitate laying the middle portion close to the side of the paint container. Placing the plastic handle in a stowed position promotes close stowage of multiple containers. The respective ends of the plastic handle, which have respective clips, have respective hub covers formed with opposed chamfered edges configured for engagement with a paint shaker machine.

In another embodiment, each clip is a unitary arrowhead shaped piece with flat sides.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example embodiment of a paint bucket onto which the plastic handle may be attached, to illustrate the hub of the bucket;

FIG. 2 is a perspective view of an example embodiment of the plastic handle attached to a paint bucket in an upraised (carrying) position, with a phantom depiction of the handle lowered against the bucket in a stowed position;

FIG. 3 is a perspective view of an example embodiment of the plastic handle;

FIG. 4 is a top plan view of the handle shown in FIG. 3;

FIG. 5 is a side elevation view of the handle shown in FIG. 3;

FIG. 6 is an enlarged side elevation view of one end of the handle shown in FIG. 3:

FIG. 7 is a perspective view of an alternate handle in which the clip is unitary; and

FIGS. 8-11 are respectively top, bottom, side, and end views of the handle shown in FIG. 7.

### DETAILED DESCRIPTION OF THE PREFERRED EMBODIMENT

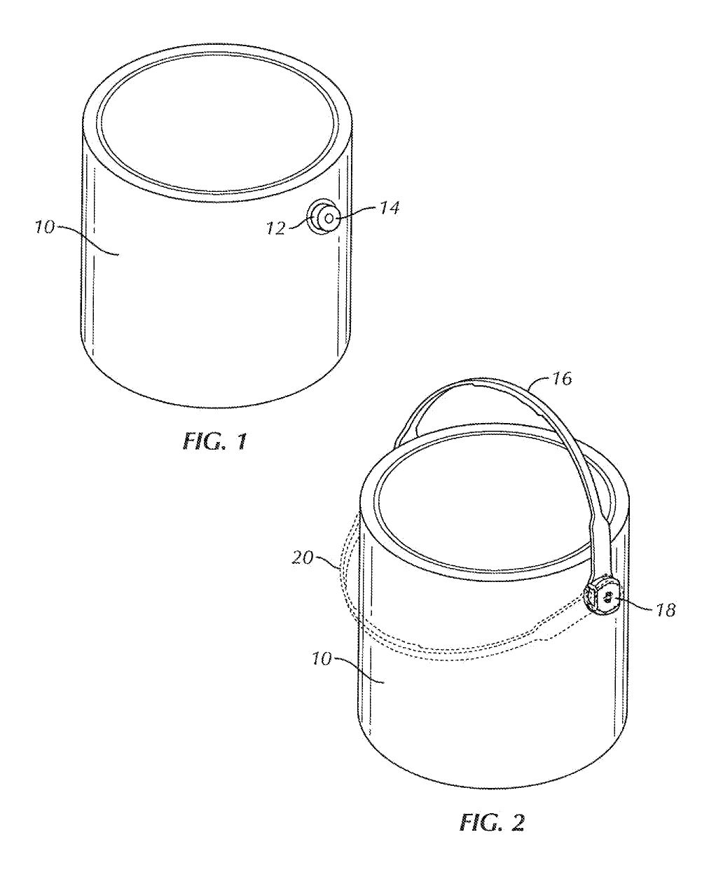

Referring initially to FIG. 1, a paint container 10 has a hub 12 with a receptacle 14. There is a hub 12 on each side of the paint container 10, although only one is shown in FIG. 1. The receptacles 14 on their respective hubs 12 are essentially holes with into which a projection of another element, such as a handle, can be inserted and anchored. The recessed internal surfaces of the hubs 12 have a protuberance on the external edge that acts as a threshold for an inserted projection.

The paint container 10 is shown in FIG. 2 having a plastic handle 16 that is attached to the hubs 12, although the hubs cannot be seen and are thus unlabeled in this figure. The plastic of which handle 16 is made may be polycarbonate, polyethylene terephthalate (PET), polypropylene, or other suitable rugged, typically hard and transversely flexible plastic. Soft plastics less desirably may be used. A raised hub cover 18 may be located at each end of the plastic handle 16. Each hub cover 18 is formed with opposed chamfered edges configured for engagement with a paint shaker machine.

When the handle 16 is in the attached state, it may be rotated to lie against the side of the paint container 10 in a stowed position. In FIG. 2, this configuration is illustrated as a phantom handle 20. Placing the handle 16 in the stowed position 20 facilitates close storage of multiple containers.

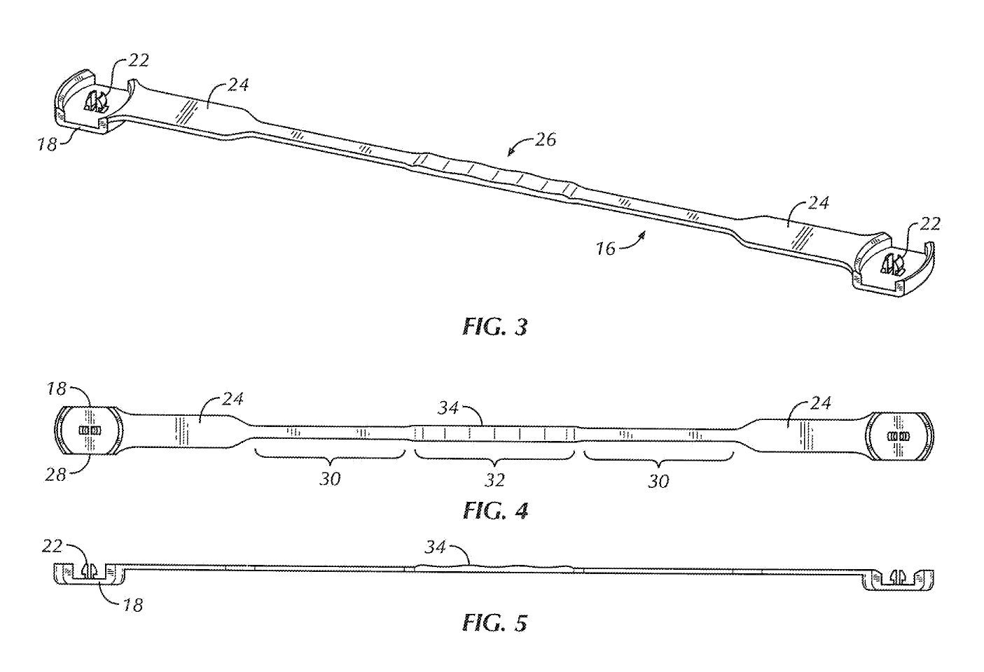

Moving in reference to FIG. 3, the perspective view of an example embodiment of a plastic handle 16, the hub covers 18 are situated at the ends of the handle 16 and are unitarily made with the body of the handle 16. In the center of the hub covers 18 are outwardly-biased, inwardly-bendable clip arms 22 that together establish a resilient clip for engaging a hub 12 of a paint container 10. Wider portions 24 of the body of the plastic handle 16 extend inwardly from each hub cover 18 and merge with a central narrower portion 26. The narrower width of this central narrow portion 26 enhances the facilitation of close storage of multiple paint containers when the handle 16 is in the stowed position 20.

FIG. 4 is a top plan view of the same plastic handle 16 shown in FIG. 3. In this illustration, opposed chamfered straight edges 28 of the hub cover 18 may easily be seen as being straight and parallel to each other. The distance between the chamfered edges 28 can be three quarters of an inch in an example embodiment. The central narrower portion 26 of the body has narrower end sections 30 that extend inwardly from the wider portions 24 of the body and are flat without bumps. The middle section 32 of the central narrower portion 26 of the body is marginally wider than the two end sections 30 but narrower than the wider portions 24, and can be formed with wave-like finger bumps 34 for gripping.

The same plastic handle shown in FIGS. 3 and 4 is also illustrated in FIG. 5 from a side elevation view. The hub covers 28 are located at each end of the handle 16 and surround two clip arms 22. The body of the handle 16 has the same depth, or thickness, seen from this view. In the center of the body are the finger bumps 34 that are located on the slightly wider middle section 32 of the central narrow portion 26.

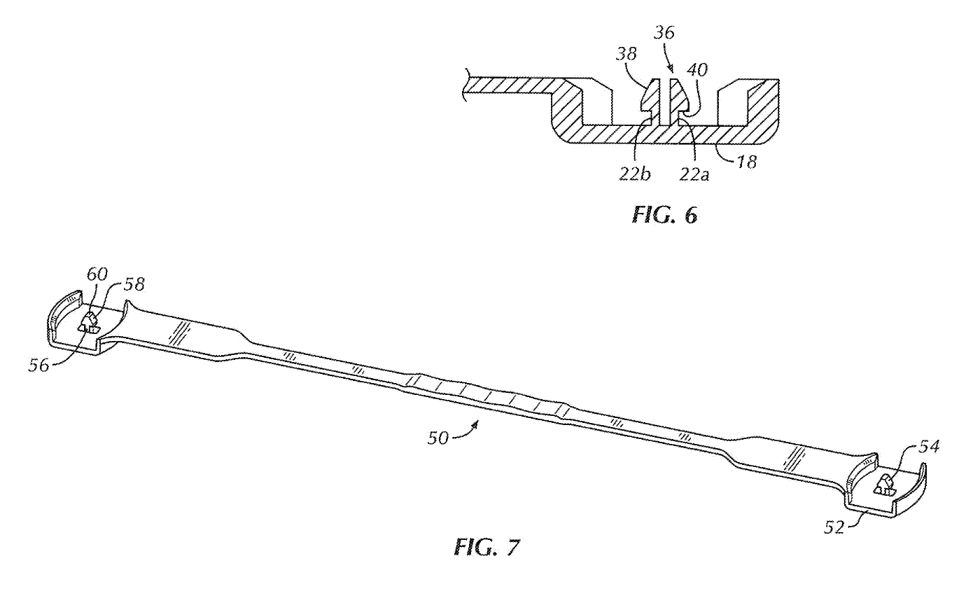

The clip arms 22 and surrounding hub cover 18 are enlarged in FIG. 6. Although only one clip arm 22a is numbered for viewing purposes, both clip arms 22 have a free end 36 at the furthest point from the hub cover 18. An outer surface 38 tapers outwardly from the free end 36 of the clip arm 22a and toward the hub cover 18. The outer surface 38 terminates at an inflection point 40 and extends back inwardly. When the clip arms 22 are advanced into a receptacle 14 of the bucket hub 12 free ends 36 first, the outer surfaces 38 of the clip arms 22 ride against a periphery of the receptacle 14, which urges the clip arms 22 toward each other, until the inflection point 40 clears the periphery, which causes the clip arms 22 to move away from each other under the influence of material bias, trapping the clip in the receptacle 14.

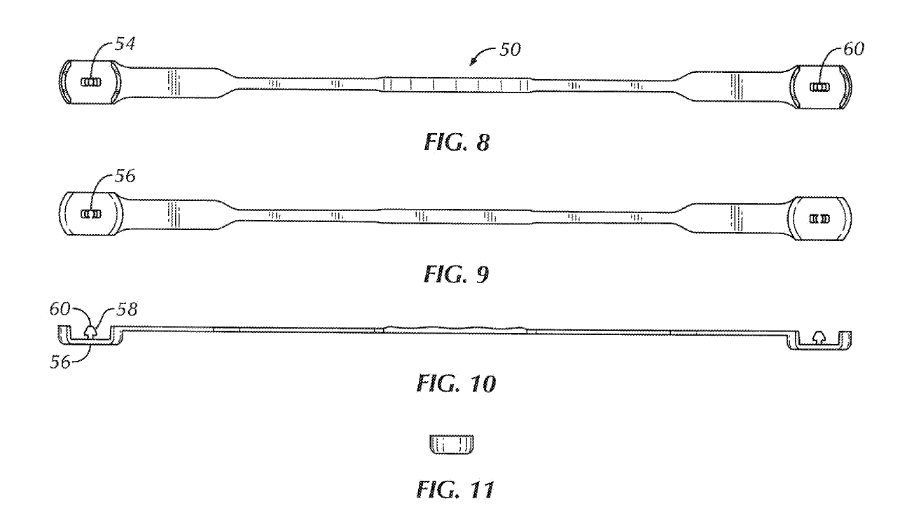

FIGS. 7-11 show an alternate embodiment of a handle 50 that is substantially identical in configuration and operation to the handle 16 shown in FIGS. 2-6 except that instead of opposed clip arms, the handle 50 has in each of its end hub covers 52 a single unitary arrow-shaped clip 54. Each clip 54 has a parallelepiped-shaped or cylindrical-shaped stalk 56 connected to its respective hub cover 52 and a generally flat triangular arrowhead 58 with the base of the arrowhead 58 merging with the stalk 56 and the tip of the arrowhead distanced from the stalk as shown. The tip may not necessarily be pointed but may be slightly chamfered as shown at 60.

While the particular PLASTIC PAINT BUCKET HANDLE is herein shown and described in detail, it is to be understood that the subject matter which is encompassed by the present invention is limited only by the claims.

What is claimed is:

1. Assembly comprising:
an elongated plastic handle for a paint bucket, the handle including:
a unitary elongated plastic body terminating at opposed ends;
respective outwardly-biased, inwardly-bendable clip arms located at each end that together establish a resilient clip for engaging a hub of a paint bucket;
a respective raised hub cover surrounding each clip, each hub cover formed with opposed chamfered edges configured for engagement with a paint shaker machine;
wider portions of the body extending inwardly from each end and merging with a central narrower portion, wherein owing to the relatively smaller width of the central narrow portion, the handle is disposed close to the paint bucket in a stowed position in which the handle is moved down against the bucket, to facilitate close stowage of multiple buckets.

2. The assembly of claim 1, wherein the body is made of hard plastic that is transversely flexible.

3. The assembly of claim 1, wherein the central narrower portion has finger bumps formed on it for gripping.

4. The assembly of claim 1, wherein the central narrower portion has a middle part and two end parts narrower than the middle part.

5. The assembly of claim 4, wherein the middle part is formed with finger bumps for gripping and the two end parts are not formed with finger bumps.

6. The assembly of claim 1, wherein each clip arm is formed with an outer surface tapering outwardly from a free end of the clip arm and then at an inflection point extending back inwardly such that when the clip is advanced into a receptacle of the bucket hub free ends first, the clip arms ride against a periphery of the receptacle, which urges the clip arms toward each other, until the inflection point clears the periphery, which causes the clip arms to move away from each other under the influence of material bias, trapping the clip in the receptacle.

7. The assembly of claim 1, wherein the opposed chamfered edges of each hub cover are straight and parallel to each other.

8. The assembly of claim 7, wherein the opposed chamfered edges define a distance between each other of three quarters of an inch.

9. Plastic handle for a paint container comprising:
elongated plastic body having opposed clip ends formed with respective clips configured for engaging respective receptacles of a paint container; and
a respective hub cover surrounding each clip and defining a non-circular periphery.

10. The handle of claim 9, wherein the body and hub covers are unitarily made with each other.

11. The handle of claim 10, comprising a pair of respective outwardly-biased, inwardly-bendable clip arms located a respective clip end, a pair of clip arms together establishing one of the clips.

12. The handle of claim 11, wherein each hub cover is formed with opposed chamfered edges configured for engagement with a paint shaker machine.

13. The handle of claim 12, wherein wider portions of the body extend inwardly from each clip end and merge with a central narrower portion, wherein owing to the relatively smaller width of the central narrow portion, the handle is disposed close to the paint container in a stowed position in which the handle is moved down against the container, to facilitate close stowage of multiple containers.

14. The handle of claim 13, wherein the central narrower portion has finger bumps formed on it for gripping.

15. The handle of claim 13, wherein the central narrower portion has a middle part and two end parts narrower than the middle part.

16. The handle of claim 15, wherein the middle part is formed with finger bumps for gripping and the two end parts are not formed with finger bumps.

17. The handle of claim 11, wherein each clip arm is formed with an outer surface tapering outwardly from a free end of the clip arm and then at an inflection point extending back inwardly such that when the clip is advanced into a receptacle of the container free ends first, the clip arms ride against a periphery of the receptacle, which urges the clip arms toward each other, until the inflection point clears the periphery, which causes the clip arms to move away from each other under the influence of material bias, trapping the clip in the receptacle.

18. The assembly of claim 12, wherein the opposed chamfered edges of each hub cover are straight and parallel to each other.

19. The handle of claim 9, wherein each clip comprises a single unitary arrow-shaped clip with a parallelepiped-shaped or cylindrical-shaped stalk connected to its respective hub cover and a generally flat triangular arrowhead with a base of the arrowhead merging with the stalk and a tip of the arrowhead distanced from the stalk.

20. Method comprising:
engaging opposed ends of an elongated plastic handle to a plastic paint container; and
providing the container with handle for carrying the container, the handle having end portions wider than a middle portion to facilitate laying the middle portion close to the container in a stowed position to promote close stowage of multiple containers, the handle having a hub cover formed with opposed chamfered edges configured for engagement with a paint shaker machine.
